(19) United States
(12) Patent Application Publication
(10) Pub. No.: US 2023/0324929 A1
(43) Pub. Date: Oct. 12, 2023

(54) SYSTEMS AND METHODS FOR ROTOR SYSTEM FOREIGN OBJECT DETECTION

(71) Applicant: Aviation Communication & Surveillance Systems, LLC, Phoenix, AZ (US)

(72) Inventor: Paul Albert Voisin, Phoenix, AZ (US)

(73) Assignee: Aviation Communication & Surveillance Systems, LLC, Phoenix, AZ (US)

(21) Appl. No.: 18/132,694

(22) Filed: Apr. 10, 2023

Related U.S. Application Data
(60) Provisional application No. 63/328,908, filed on Apr. 8, 2022.

(51) Int. Cl. G05D 1/10; G05D 1/00

(52) U.S. Cl. CPC G05D 1/106; G05D 1/102; G05D 1/0094

(57) ABSTRACT

Embodiments of the present invention provide for the detection/identification of objects near a rotary-wing/VTOL aircraft such as a helicopter, drone, or an eVTOL (electric Vertical Take Off & Landing) aircraft using LiDAR. Various aspects of the present invention may include installation of one or more LiDAR devices on a mast of a rotor system of a rotary-wing/VTOL aircraft. The LiDAR device(s) may be pointing outward from the central axis of the mast and may be aligned to avoid interference form the rotor blades. Multiple LiDAR devices may be oriented/pointed above, below or in-plane with the rotor system. As the mast rotates, the LiDAR is pulsed providing a range to objects near the rotor system as the LiDAR emitted beams are scanned through the 360 degree rotation of the rotor mast. A processor determines whether objects detected within the detection envelope/volume represent a threat or hazard condition to the aircraft.

### CROSS REFERENCE TO RELATED APPLICATIONS

This application claims the full benefit of and priority to U.S. provisional patent application No. 63/328,908 filed Apr. 8, 2023 titled, “SYSTEMS AND METHODS FOR ROTOR SYSTEM FOREIGN OBJECT DETECTION,” the disclosure of which is fully incorporated herein by reference for all purposes.

### FIELD AND BACKGROUND OF THE INVENTION

### Field of the Invention

The present disclosure relates to improving safe operation of rotary-wing and eVTOL aircraft. More particularly, embodiments of the present invention provide for improved detection of objects that may present hazards when operating rotary-wing and vertical take-off and landing (VTOL) aircraft in proximity to surface or ground locations.

### Background of the Invention

Operation of rotary-wing and VTOL aircraft (including, but not limited to electric vertical takeoff and landing aircraft such as drones) is often perilous when conducted in proximity to ground- or surface-based obstacles. Buildings, trees, towers, power lines, people, ship superstructures, and other aircraft are just a few examples of objects that could cause catastrophic damage or crashes if struck by the rotary wing elements of such aircraft, and the risks can be further enhanced by variable surface winds or gusts that can make the aircraft move in an unpredictable manner in areas having restricted freedom of safe horizontal movement.

Accordingly, rotary-wing and VTOL aircraft manufacturers and operators desire enhanced situational awareness solutions that improve the ability for pilots to receive identification of proximate hazards to aircraft operations; for example, onboard systems to detect and annunciate to the vehicle operator(s) when there are objects in proximity to the aircraft rotor operating envelope that could result in damage to the rotors and aircraft if such objects were struck by the rotors.

Current solutions require the use of multiple non-cooperative sensors installed at separate locations on a rotary-wing or VTOL airframe to be able to provide full geometrical 360 degree azimuthal coverage for surveillance of objects that are within the aircraft's vehicle rotor system operating envelope. However, for most applications, use of multiple sensors and the integration of the data provided by these sensors can be prohibitively costly to equip the aircraft for 360-degree coverage for object detection.

Light Detection and Ranging (LiDAR) devices emit pulsed laser light (a collimated beam at a specific wavelength). Objects within the beam of the laser light (wall, person, pole, other aircraft etc.) reflect back a portion of the emitted laser light energy which may be reflected back and enter a detector. Circuits may then measure the time-of-flight and determine the distance the light traveled (emitter to object to detector). By this method, the distance from the LiDAR device to the object can be accurately determined, and time of emission and receipt of the laser pulse can indicate relative azimuth/angular direction of the detected object. Various approaches have been implemented in past LiDAR installations including a single vector or scan of a large field-of-view by rotating (mechanical) or using a moving mirror (MEMs). However, cost-effective LiDAR solutions in protecting rotary-wing/VTOL aircraft in surface-proximate operations have previously not been developed.

What is needed is a low cost, light weight sensor module that may be installed in rotary-wing/VTOL aircraft that provides continuous 360 degree unobstructed surveillance of the environment near the aircraft.

### SUMMARY OF THE INVENTION

The following presents a general summary of aspects of this invention in order to provide a basic understanding of at least some aspects of the invention. This summary is not an extensive overview of the invention. It is not intended to identify key or critical elements of the invention or to delineate the scope of the invention. The following Summary merely presents some concepts of the invention in a general form as a prelude to the more detailed description provided below.

Embodiments of the present invention provide for the detection/identification of objects near the rotor system of a rotary-wing/VTOL aircraft such as a helicopter, drone, or an eVTOL (electric Vertical Take Off & Landing) aircraft using LiDAR. Various aspects of the present invention may include installation of one or more LiDAR devices on a mast of a rotor system of a rotary-wing/VTOL aircraft. The LiDAR device(s) may be pointing outward from the central axis of the mast and may be aligned to avoid interference form the rotor blades. Multiple LiDAR devices may be oriented/pointed above, below or in-plane with the rotor system. As the mast rotates, the LiDAR is pulsed providing a range to objects near the rotor system as the LiDAR emitted beams are scanned through the 360 degree rotation of the rotor mast. Emitted and reflected LiDAR beams may create a cone-shaped detection envelope, and when the detection envelope is swept through space by rotation of the rotor mast, a torus-like or annular-shaped detection volume may be created that surrounds the aircraft where objects within the detection volume may be identified and reported.

In various implementations, the azimuth of the LiDAR pulses may be converted to the aircraft azimuth by any suitable means, such as magnetic pickup, aircraft structure detection, pulse timing with rotor revolution, or other techniques. For example, but not by way of limitation, LiDAR reflections from a portion of the aircraft such as the tail rotor can provide a landmark to calibrate azimuth data and calculate bearing/azimuth of a detected object relative to the orientation of the aircraft. Both the range and azimuth data are sent from the LiDAR module to a Processing Computer. The Processing Computer may use different algorithms based upon mode of flight (in-air, taxi, stationary) to classify objects and provide alerts to the operator. It is also possible to locate the LiDAR device proximate the rotor blade (tip); however, the area of detection (relative to aircraft body) may be altered by the rotor blade's plane of travel.

Embodiments of the system of present invention (also referred to herein as the “SafeRotor System”) may be self-powered by placing an electrical generator at, for example, a swashplate (which has both non-rotating and rotating components). In various embodiments, data from the SafeRotor System is wirelessly transmitted to the Processing Computer/Sensor Processing Unit that may be located within the airframe of the aircraft. Therefore, embodiments of the present invention can be installed without modifying the existing mast and rotor system, further reducing cost, complexity, and weight compared to previous or alternative solutions.

The Processing Computer may use the raw range and azimuth, mathematically compute object detection and provide the information (e.g., digital, graphical, audio, video, or other formats) to the cockpit for display/annunciation to the pilot. Data from the SafeRotor System sensors may be coupled with current surveillance products and a Sensor Processing Unit (SPU) to complete the processing, alerting and display of nearby hazards.

An embodiment of the present invention may include a system comprising: a mast sensor transmitter unit (“MST”) mechanically coupled to a provided rotary mast of a provided rotary-wing aircraft, where the MST comprises: a processor coupled to a LiDAR emitter, a LiDAR detector, and a memory; a transceiver coupled to the processor and an antenna; a housing; a removable clamping unit providing mechanical coupling between the rotary mast and the MST. In this exemplary system, the processor is configured to execute instructions stored in the memory that perform the steps of: transmitting a laser pulse from the LiDAR emitter; receiving a reflection from the emitted laser pulse by the LiDAR detector; measuring and storing in the memory data regarding at least one of: a time between pulse emissions, and an azimuth angle of the rotary mast when the reflection was received; and formatting a message for transmission to a sensor processing unit (SPU), the message containing the stored data; and wherein the MST is attached to the mast and oriented so that laser beams emitting from the LiDAR emitter are not substantially blocked by the blades of the rotary wing. Method steps of the system may also comprise transmitting the message to the SPU, and in one embodiment, the MST emits and measures a plurality of laser pulses as the rotor is turned in normal operation by the aircraft and the plurality of measured laser pulses is transmitted to the SPU for analysis to determine whether an object hazard exists within a detection volume scanned by the LiDAR emitter and detector. The system may also include any appropriate sensor or circuit element, for example, one or more of a camera, an accelerometer, centrifugal switch, and a ground test switch. The MSU may be secured in any preferred location, such as to the rotary mast below the blades of the rotary-wing aircraft, or proximate a top end of the rotary mast above the blades of the rotary wing aircraft.

The system may also comprise a sensor power generator (SPG) mechanically coupled to the rotary mast and electrically coupled to the MST, and may further comprise: a housing/mount including one or more pick-off coils and a roller bearing for supporting axial rotation of an inner race thereby, wherein: the inner race is mechanically coupled to one or more external vanes; the inner race includes one or more permanent magnets that are embedded within and disposed near a surface of the inner race proximal to an area near the one or more pick-off coils within the housing mount; the housing/mount is configured to rotate with the operational rotation of the rotary-wing rotor mast; the rotor is configured to receive mechanical drag producing a differential angular velocity between the rotor and the housing/mount; and an electrical current is generated by the rotation of the inner race causing the one or more permanent magnets embedded in the rotor to pass by the one or more pick-off coils through the relative angular velocities of the rotor and the housing/mount attached to the rotary mast. In one aspect, the electrical current is provided to a power circuit card assembly of the MST to condition the provided current and provide operational power for the MST, and in an additional aspect, the housing/mount is mechanically coupled to the rotor mast through a clamping mechanism. In another embodiment, the sensor power generator is mounted proximate a top end of the rotary mast.

Embodiments of the present invention also include a system processing unit (SPU) that further comprises: a communication interface coupled to an SPU processor, the communication interface including an SPU transceiver coupled to an SPU antenna; and an SPU memory coupled to the SPU processor, wherein the SPU processor executes program steps stored within the SPU memory to perform the steps of: receiving the transmitted message; analyzing the data from the received message to determine one or more of a range and a bearing to a detected object reflecting the emitted LiDAR pulse. The SPU processor may determine whether the range and/or bearing to the object represents a hazardous condition, and determining whether the range and/or bearing to the object represents a hazardous condition may comprise determining that the range and/or bearing is located within a predetermined distance and/or bearing in a predefined protected volume surrounding the aircraft. In another aspect, determining whether the range and/or bearing to the object represents a hazardous condition comprises determining that the range is located within a predetermined distance in a predefined protected volume surrounding the aircraft. The SPU may be installed either within the airframe of the aircraft, or in an alternate embodiment, outside of the airframe of the aircraft.

In one embodiment, the SPU may be further coupled to an alert display module (ADM) comprising one or more of a display, a speaker, and a user interface. The SPU may transmit the range and a bearing to the object reflecting the emitted LiDAR pulse to the ADM. The ADM may provide a visual indication of a location of the detected object with respect to the aircraft, and in another embodiment, the ADM may provide one or more of a visual warning and an aural warning indicating the object represents a potential threat or hazard to operation of the aircraft. In yet another embodiment, the ADM may provide one or more of: a displayed range and/or bearing of the detected object with respect to the aircraft; and an aural indication of the range and/or bearing of the detected object with respect to the aircraft.

### BRIEF DESCRIPTION OF THE DRAWINGS

A more complete understanding of the present invention may be derived by referring to the detailed description and claims when considered in connection with the following illustrative figures.

FIG. 1 illustrates a high-level block diagram of a system embodiment of the present invention.

FIG. 2 illustrates a flowchart of a method embodiment of the present invention.

FIG. 2A shows a detailed block diagram of the SPU, MST, and ADM sub-systems of the present invention.

FIG. 3 is a partial plan view of a rotor assembly of a rotary-wing aircraft, showing an attached embodiment of an MST of the present invention.

FIG. 4 shows a top plan view of a rotary-wing aircraft showing an exemplary LiDAR orientation of the present invention.

FIG. 5 illustrates a front plan view of a rotary-wing aircraft, depicting an example LiDAR detection envelope according to embodiments of the present invention.

FIG. 6 shows a perspective partial exploded view of an MST sub-assembly of the present invention.

FIG. 7 shows another perspective partial exploded view of an MST sub-assembly of the present invention.

FIG. 8 illustrates a perspective view of a sensor circuit card assembly of the present invention.

FIG. 9A shows a perspective partial exploded view of a top-mast mount MST of the present invention.

FIG. 9B illustrates a perspective view of the closed assembly of FIG. 9A.

FIG. 10A illustrates a partial perspective view one embodiment of a mast-mounted sensor power generator.

FIG. 10B illustrates a partial elevation (cutaway) view of a sensor power generator of the present invention.

Identical reference numerals between the drawings are intended to refer to the same or similar parts.

### DETAILED DESCRIPTION

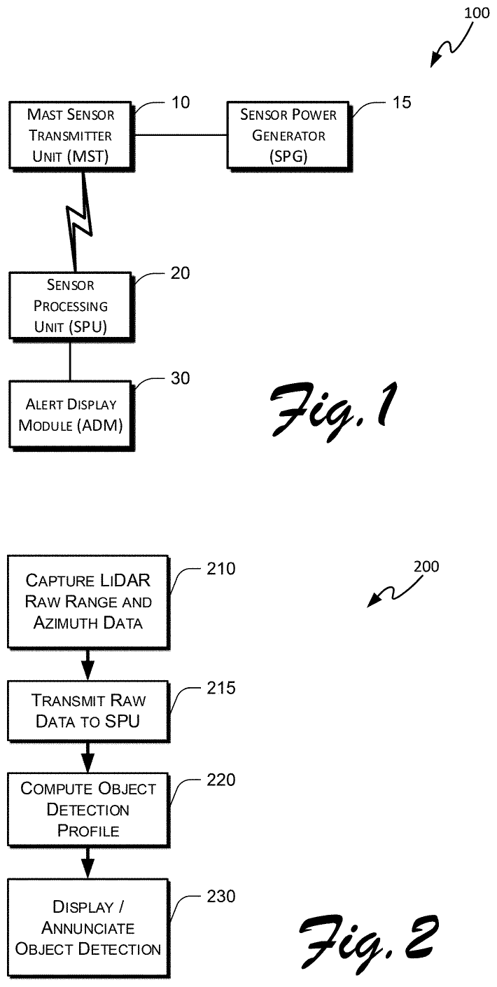

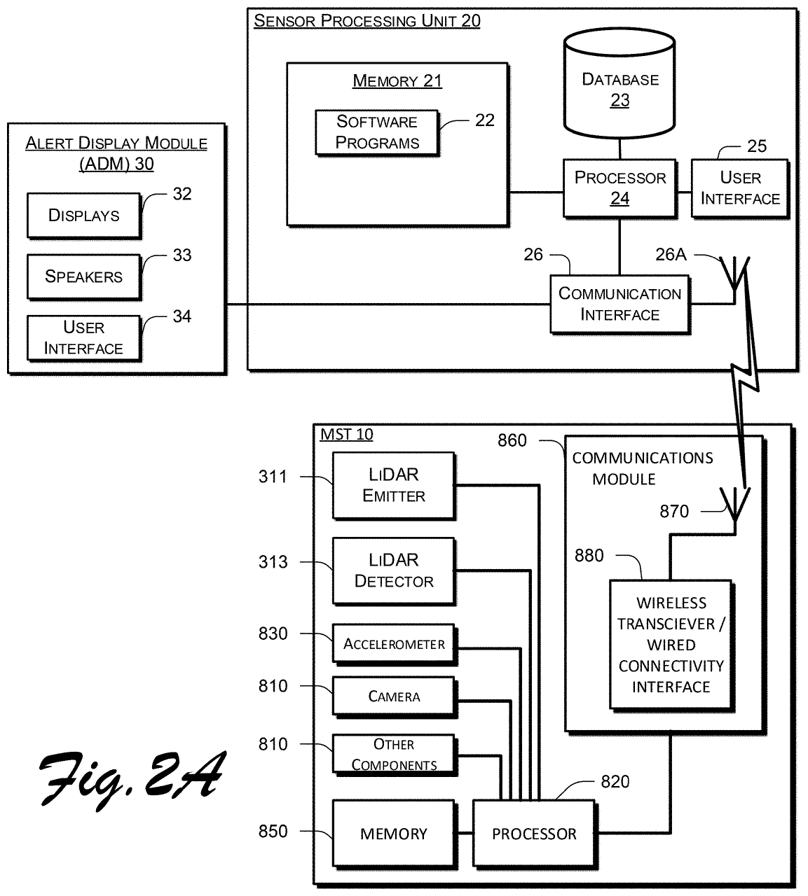

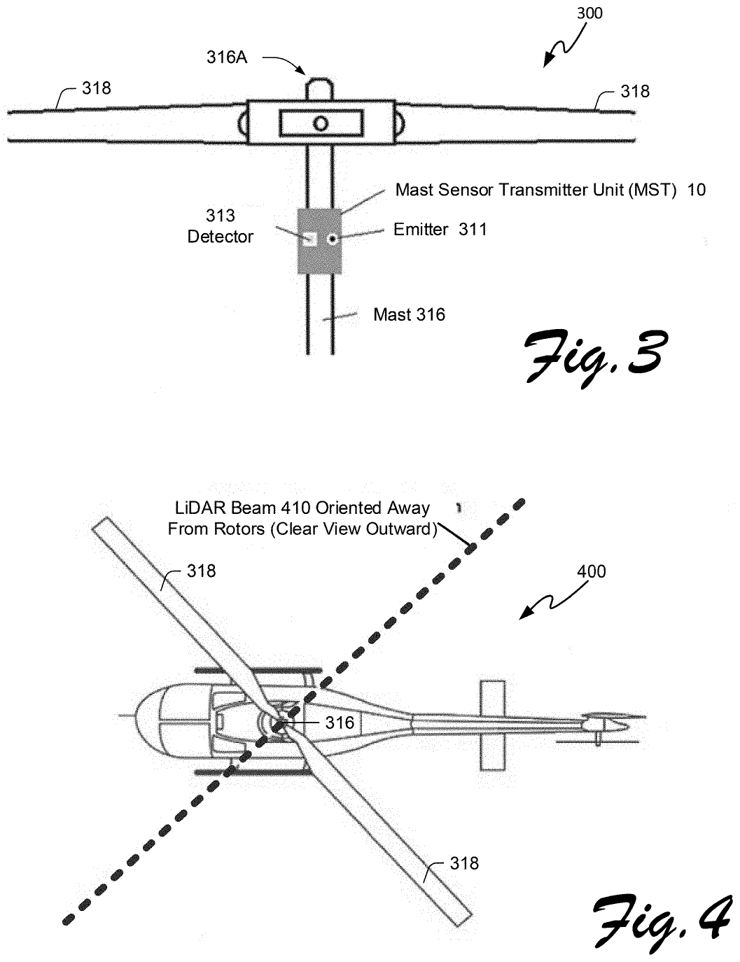

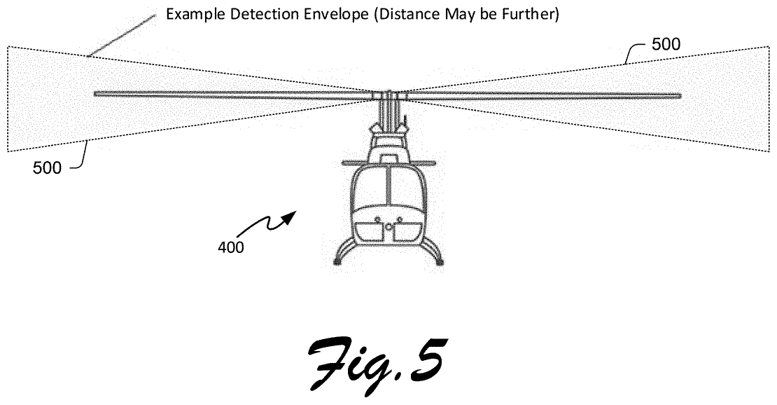

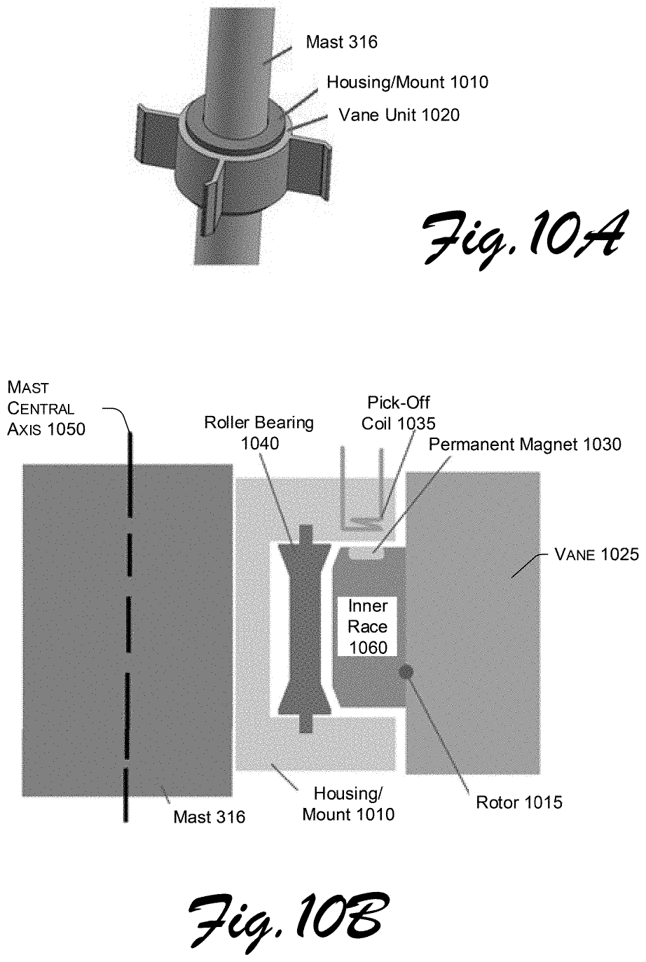

FIGS. 1 and 2A illustrate block diagrams of system implementations of the present invention. The following discussion also includes methods illustrated in FIG. 2, and an aircraft mast system 300 illustrated in FIG. 3. In various embodiments, the SafeRotor System 100 includes one or more Mast Sensor Transmitter Unit (MST) 10 that is installed on a mast (FIG. 3, 316) of an aircraft and optionally coupled to a Sensor Power Generator (SPG) 15. The MST 10 wirelessly communicates through transceiver 880 and antenna 870 to the Sensor Processing Unit (SPU) 20 through communications interface 26, which is further electrically coupled to an Alert Display Module (ADM) 30 comprising one or more cockpit displays 32 (whether used as part of a dedicated display or a multifunctional display) and/or cockpit speakers 34 and an optional user interface 34. In an alternative embodiment, the MST 10 may be electrically coupled to the communication interface of the SPU 20 through a wired connection. The MST 10 produces and captures (210) raw range and azimuth data, and wirelessly transmits (215) the data to the Sensor Processing Unit (SPU) 20, which is typically located within the airframe of the aircraft, but in some embodiments may be located outside the airframe. The processor 24 of the SPU 20 may execute programs 22 stored in the memory 21 to mathematically compute an object detection profile 220 and provide information such as ranging and azimuth information in a desired format (e.g., digital, graphical, audio, video, or other formats) to the cockpit for display/annunciation 230 to the pilot or cockpit personnel through the cockpit ADM 30. The MST 10 may be battery powered, or in various implementations, the Sensor Power Generator 15 supplies power to the MST 10 using generator elements installed proximate the rotor system of the aircraft to utilize rotary motion to generate power. The electrical generator can be placed in the air flow or at the swashplate (which has both non-rotating and rotating components). The SPG 15 is discussed in more below in regards to FIGS. 10A and 10B.

The SPU 20 may receive inputs from multiple different types of non-cooperative sensor inputs through MST 10. These sensors may include electro-optic (EO) cameras 810 and LiDARs 311/313 and can also include infrared (IR) cameras, radars or other sensor types 810. The SPU 20 may serve as the main interface to the sensors. The SPU 20 may include an internal transceiver/communications interface 26 and antenna 26A, which may receive data transmitted from the MST 10, and in some embodiments may communicate control or command information to the MST 10. The data received by the SPU 20 from the MST 10 may comprise LiDAR sensor range/bearing data, camera image data, and MST 10 status. The SPU 20 may receive from the MST 10 raw data regarding each of the sensor images and/or detections and using the processor 24 to calculate the presence of objects/obstacles in the field of view of the LiDAR emitted pulses, calculating their range, bearing/azimuth with respect to the aircraft, and threat characteristics, and passing this information to the flight crew. For example, but not by way of limitation, the SPU processor 24 may identify an object from the LiDAR data that exists within a predetermined distance and/or bearing with respect to the aircraft, and may further determine that the presence of the object within the predetermined distance/azimuth may constitute a threat or hazardous condition. Likewise, in various embodiments, the processor 24 may determine either the range and/or bearing to the object represents a hazardous condition by determining that the range and/or bearing is located within a predetermined distance and/or bearing in a predefined protected volume surrounding the aircraft. In an alternative embodiment, a hazardous condition may be determined by detection, by the SPU processor 24, that a detected object's range occurs within the predefined protected volume around the aircraft without regard to the bearing of the object.

Algorithms stored in a memory 21 within the SPU 20 may be executed by a processor 24 of the SPU 20 to align the sensor data to the aircraft and complete the detection process. Processed data from the SPU 20 may be sent to the cockpit and core avionics in the same manner as detections from other sensors, and may be presented as visual and/or audio information to the flight crew through the ADM 30. In some embodiments, the flight crew may be provided access to user interface a control panel 25 to manage the SafeRotor's system functions.

The functionality of the SPU 20 and MST 10 may also be implemented through various hardware components storing machine-readable instructions, such as application-specific integrated circuits (ASICs), field-programmable gate arrays (FPGAs) and/or complex programmable logic devices (CPLDs), graphics processing units (GPUs), and neural network processing or simulation circuits. Systems according to aspects of the present invention may operate in conjunction with any desired combination of software and/or hardware components.

The processors 24, 820 respectively retrieve and execute instructions stored in the respective memories 21, 850 to control the operation of the respective devices 20, 10. Any number and type of processor such as an integrated circuit microprocessor, microcontroller, and/or digital signal processor (DSP), can be used in conjunction with the present invention. The memories 21, 850, respectively store instructions, data, messages transmitted from (or received by) either of the SPU 20 or MST 10, and any other suitable information. A memories 21, 850 operating in conjunction with the present invention may include any combination of different memory storage devices, such as hard drives, random access memory (RAM), read only memory (ROM), FLASH memory, or any other type of volatile and/or nonvolatile memory. Data can be stored in the respective memories 21, 850 in any desired manner.

As illustrated in FIGS. 3-4, embodiments of the present invention may place one or more LiDAR-based devices such as an MST 10 on the mast 316 of a rotor system 300 of an aircraft 400. The MST 10 device(s) may be installed and aligned with emitters 311/detectors 313 oriented outward from the mast 316 and arranged to point in a direction removed from the rotor blades 318 (for example, MST 10 is arranged to produce LiDAR beam 410 shown approximately orthogonally to the blades in FIG. 4). Such arrangements provide the clearest path for the LiDAR beams to detect objects without interference by the rotor blades 318. Multiple LiDAR devices may be pointed/aimed above, below or in-plane with the rotor system 300 of the aircraft 400. As the mast 316 rotates, the LiDAR emitter 311 is pulsed, and the reflections received by the detector 313 provide raw data for determining a range to objects in proximity the rotor system 300. Such arrangement may create a conic- or triangle-shaped detection envelope as illustrated in FIG. 5, 500, and the vertical and horizontal extent of the detection envelope 500 may vary in different embodiments.

In various embodiments, the MST 10 could be implemented in either a mast clamp mount or top mast mount unit. The functionality of the MST 10 may be the same for either mounting type, or could vary as desired.

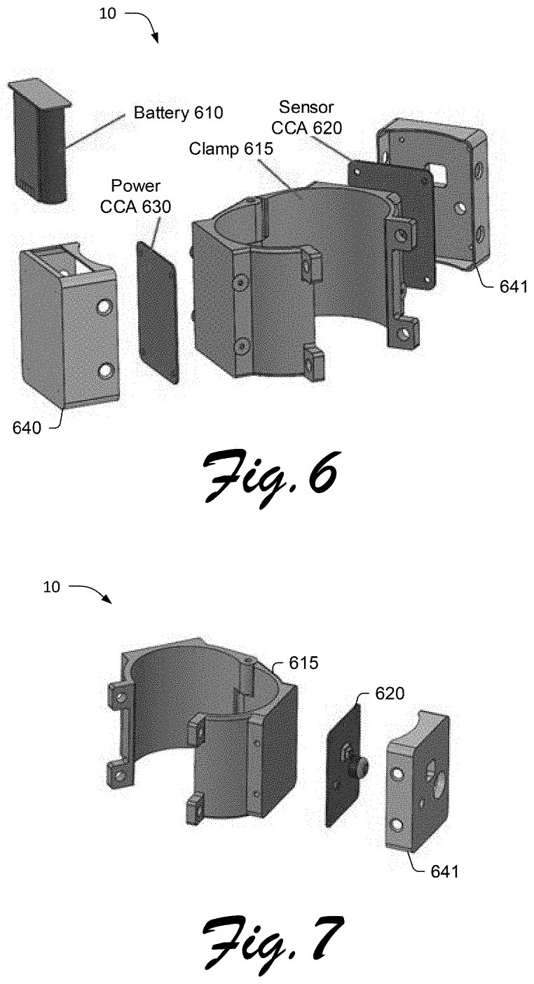

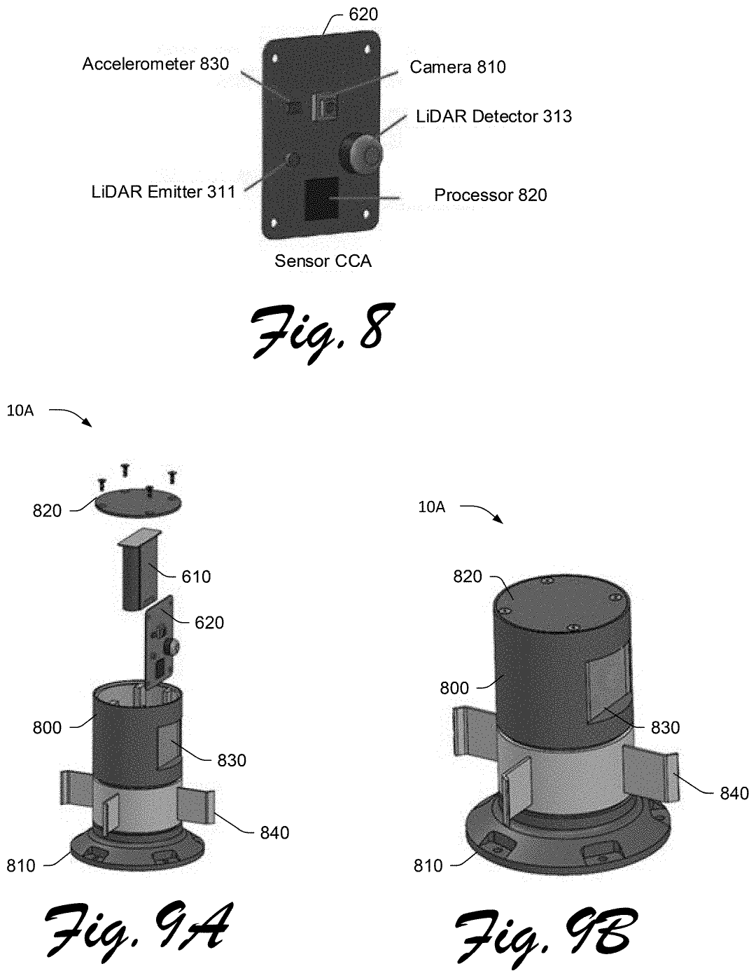

As illustrated in FIGS. 6-7, the clamp mount-style MST 10 may comprise a two-part clamshell design that mounts directly to the aircraft/helicopter mast 316. The MST 10 may comprise of the following sub items: two-part housing 640, 641, clamp mount 615, battery 610, sensor Circuit Card Assembly (CCA) 620 and power CCA 630. Further, as shown in FIG. 8, the sensor CCA 620 may contain the light detection and Ranging (LiDAR) emitter 311 and detector 313, one or more cameras 810, processor 820, and accelerometers 830. The MST 10 may also include one or more of a transmitter, antenna, centrifugal switch, ground test switch and associated electrical circuits (not shown to simplify the illustration). The MST 10 may be installed to orient in any desired angle between any rotor blades 318 to obtain a view of the surrounding environment with minimal interference from the rotor blades 318. In various embodiments, the clamp-mount MST 10 may easily removed/re-installed to allow for periodic inspection of the mast 316. Additionally, weight distribution of the MST 316 may be designed to be within the balance adjustment envelope of the main rotor system 300, and may include counterweights if desired in various implementations to improve rotor balance (for example, disposed in a position on the mast 316 behind the MST 10).

As shown in FIGS. 9A and 9B, embodiments of the present invention provide for an MST 10A that may be mounted proximate to a top portion (FIG. 3, 316A) of the mast 316. The top mount design may be fixed above the main rotor. While the packing of the internal components may differ in arrangement, the components discussed in accordance with FIGS. 6-8 are similar, with the exception of the housing halves 640, 641 and clamp 615, and in one embodiment, all functions may remain the same. More particularly, FIG. 9A shows an exploded view of the top-mount MST 10A, which is illustrated assembled in FIG. 9B. This embodiment is shown including a cylindrical housing 800, a mounting flange 810, a flush-mount top cap and fasteners 820, and transparent environmental isolation window 830. Components sensor CCA 620 and battery 610 are shown in FIG. 9A external to the MST 10A to illustrate exemplary installation positions. In one embodiment, a vane section 840 is disposed to rotatably operate around the central vertical axis of the MST 10A, and is coupled to an interior rotor of a generator unit to provide power to the MST 10A. The vanes are shaped so as to provide external drag to rotate the vane unit, which in turn moves embedded magnets by pick-up coils, generating current to provide power to the MST 10A. A slightly different embodiment is discussed below in regards to FIGS. 10A and 10B.

FIGS. 10A and 10B respectively illustrate a perspective view and partial side cut-away view of the sensor power generator (SPG) 15, which may provide an optional source of power for the MST 10. The SPG 15 may also mount directly to the mast 316 using a clamshell design for the housing/mount 1010 and rotor 1015. Each housing/mount half may contain a set of roller bearings 1040 and a pick-off coil 1035. The roller bearings 1040 may be spring-mounted to account for normal variances in mast 316 diameter and vibration. The two halves of the rotor 1015 may be joined to form a continuous ring. The rotor 1015 may have an inner race which may ride on the roller bearings 1040, permanent magnets 1030 for coil 1035 excitation and external vanes 1025 which provide drag.

During operation, the mast 316 and SPG housing/mount 1010 may be rotating at the same RPM due to the mechanical coupling of the housing/mount to the mast 316. The vanes 1025 on the SPG rotor 1015 interact with the surrounding air to create drag, causing the rotor 315 to spin more slowly than the housing/mount 1010. The differential in rotational speed moves the permanent magnets 1030 past the pick-off coil(s) 1035, creating an AC current that can be transformed, rectified and/or filtered to power the MST 10.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A system comprising:
a mast sensor transmitter unit (“MST”) mechanically coupled to a provided rotary mast of a provided rotary-wing aircraft, the MST comprising:
a processor coupled to a LiDAR emitter, a LiDAR detector, and a memory;
a transceiver coupled to the processor and an antenna;
a housing;
a removable clamping unit providing mechanical coupling between the rotary mast and the MST; and
wherein the processor is configured to execute instructions stored in the memory that perform the steps of:
transmitting a laser pulse from the LiDAR emitter;
receiving a reflection from the emitted laser pulse by the LiDAR detector;
measuring and storing in the memory data regarding at least one of:
a time between pulse emissions, and
an azimuth angle of the rotary mast when the reflection was received; and
formatting a message for transmission to a sensor processing unit (SPU), the message containing the stored data; and
wherein the MST is attached to the mast and oriented so that laser beams emitting from the LiDAR emitter are not substantially blocked by the blades of the rotary wing.

2. The system of claim 1, further comprising one or more of a camera, an accelerometer, centrifugal switch, and a ground test switch.

3. The system of claim 1, further comprising transmitting the message to the SPU.

4. The system of claim 1, wherein the MST is secured to the rotary mast below the blades of the rotary-wing aircraft.

5. The system of claim 1, wherein the MST is mechanically secured proximate a top end of the rotary mast above the blades of the rotary wing aircraft.

6. The system of claim 1, further comprising a sensor power generator mechanically coupled to the rotary mast and electrically coupled to the MST.

7. The system of claim 6, further comprising:
a housing/mount including one or more pick-off coils; and
a roller bearing for supporting axial rotation of an inner race thereby, wherein:
the inner race is mechanically coupled to one or more external vanes;
the inner race includes one or more permanent magnets that are embedded within and disposed near a surface of the inner race proximal to an area near the one or more pick-off coils within the housing mount;
the housing/mount is configured to rotate with the operational rotation of the rotary-wing rotor mast;
the rotor is configured to receive mechanical drag producing a differential angular velocity between the rotor and the housing/mount; and
an electrical current is generated by the rotation of the inner race causing the one or more permanent magnets embedded in the rotor to pass by the one or more pick-off coils through the relative angular velocities of the rotor and the housing/mount attached to the rotary mast.

8. The system of claim 7, wherein the electrical current is provided to a power circuit card assembly of the MST to condition the provided current and provide operational power for the MST.

9. The system of claim 7, wherein the housing/mount is mechanically coupled to the rotor mast through a clamping mechanism.

10. The system of claim 6, wherein the sensor power generator is mounted proximate a top end of the rotary mast.

11. The system of claim 3, wherein the SPU further comprises:
a communication interface coupled to an SPU processor, the communication interface including an SPU transceiver coupled to an SPU antenna; and
an SPU memory coupled to the SPU processor, wherein the SPU processor executes program steps stored within the SPU memory to perform the steps of:
receiving the transmitted message;
analyzing the data from the received message to determine one or more of a range and a bearing to a detected object reflecting the emitted LiDAR pulse.

12. The system of claim 11, further comprising determining, by the SPU processor, whether the range and/or bearing to the object represents a hazardous condition.

13. The system of claim 12, wherein the determining whether the range and/or bearing to the object represents a hazardous condition comprises determining that the range and/or bearing is located within a predetermined distance and/or bearing in a predefined protected volume surrounding the aircraft.

14. The system of claim 12, wherein the determining whether the range and/or bearing to the object represents a hazardous condition comprises determining that the range is located within a predetermined distance in a predefined protected volume surrounding the aircraft.

15. The system of claim 11, wherein the SPU is installed within the airframe of the aircraft.

16. The system of claim 11, wherein the SPU processor transmits the range and a bearing to the object reflecting the emitted LiDAR pulse to an Alert Display Module (ADM), the ADM comprising one or more of a display, a speaker, and a user interface.

17. The system of claim 16, wherein the ADM provides a visual indication of a location of the detected object with respect to the aircraft.

18. The system of claim 16, wherein the ADM provides one or more of a visual warning and an aural warning indicating the object represents a potential threat or hazard to operation of the aircraft.

19. The system of claim 16, wherein the ADM provides one or more of:
a displayed range and/or bearing of the detected object with respect to the aircraft; and
an aural indication of the range and/or bearing of the detected object with respect to the aircraft.

20. The system of claim 1, wherein:
the MST emits and measures a plurality of laser pulses as the rotor is turned in normal operation by the aircraft; and
the plurality of measured laser pulses is transmitted to the SPU for analysis to determine whether an object hazard exists within a detection volume scanned by the LiDAR emitter and detector.
